(19) United States
(12) Patent Application Publication
(10) Pub. No.: US 2025/0001302 A1
(43) Pub. Date: Jan. 2, 2025

(54) VIRTUAL ITEM DISPLAY

(71) Applicant: Tencent Technology (Shenzhen) Company Limited, Shenzhen (CN)

(72) Inventor: Lingyun LIN, Shenzhen (CN)

(73) Assignee: Tencent Technology (Shenzhen) Company Limited, Shenzhen (CN)

(21) Appl. No.: 18/886,883

(22) Filed: Sep. 16, 2024

Related U.S. Application Data
(63) Continuation of application No. PCT/CN2023/111473, filed on Aug. 7, 2023.

(30) Foreign Application Priority Data
Sep. 8, 2022 (CN) 202211098065.5

(51) Int. Cl. A63F 13/537

(52) U.S. Cl. CPC A63F 13/537

(57) ABSTRACT

In a method for displaying a virtual item in a virtual scene, a first scene image of the virtual scene is displayed from a perspective of a controllable virtual character. An input is received to utilize a sight accessory on a virtual weapon held by the controllable virtual character. A second scene image of the virtual scene is displayed as viewed through the sight accessory, the second scene image including an outline of the sight accessory. An eyepiece shadow and an objective lens shadow are rendered within an inner region of the outline. The eyepiece shadow simulates a shadow cast by an eyepiece end of the sight accessory, and the objective lens shadow simulates a shadow cast by an objective lens end of the sight accessory.

### RELATED APPLICATION

The present application is a continuation of International Application No. PCT/CN2023/111473, entitled “VIRTUAL ITEM DISPLAY METHOD AND APPARATUS, DEVICE, MEDIUM, AND PROGRAM PRODUCT” and filed on Aug. 7, 2023, which claims priority to Chinese Patent Application No. 202211098065.5, entitled “VIRTUAL ITEM DISPLAY METHOD AND APPARATUS, DEVICE, MEDIUM, AND PROGRAM PRODUCT” and filed on Sep. 8, 2022. The entire disclosures of the prior applications are hereby incorporated by reference.

### FIELD OF THE TECHNOLOGY

This application relates to the field of interface interaction, including a virtual item display method.

### BACKGROUND OF THE DISCLOSURE

In a virtual scene that includes a virtual object, a user can usually manipulate the virtual object, and perform various actions or events in the virtual scene by using a virtual item. For example, in a game, a player can control a virtual object to perform, by using a virtual gun, shooting. The virtual gun is equipped with a sight accessory, configured to allow the player to observe, through the sight accessory, a shooting target.

In the related art, when controlling the virtual object to open the sight accessory, the player can usually view an aiming down sight animation. The aiming down sight animation is configured for displaying a changing process of an image size and a location of a lens after the sight accessory is opened, thereby increasing a sense of reality when the player controls the virtual character to perform shooting in the virtual scene.

However, the changing process of the image and the location of the lens of the sight accessory that is usually displayed in the aiming down sight animation is rigid. As a result, a sense of reality brought by the lens of the sight accessory is low, and an experience of the player is poor, which in turn results in low accuracy when shooting is performed by using the sight accessory.

### SUMMARY

Embodiments of this disclosure include a virtual item display method, apparatus, and a non-transitory computer-readable storage medium. Examples of technical solutions in the embodiments of this disclosure may be implemented as follows:

An aspect of this disclosure provides a method for displaying a virtual item in a virtual scene. For example, in a displaying method, a first scene image of the virtual scene is displayed from a perspective of a controllable virtual character. An input is received to utilize a sight accessory on a virtual weapon held by the controllable virtual character. A second scene image of the virtual scene is displayed as viewed through the sight accessory, the second scene image including an outline of the sight accessory. An eyepiece shadow and an objective lens shadow are rendered within an inner region of the outline. The eyepiece shadow simulates a shadow cast by an eyepiece end of the sight accessory, and the objective lens shadow simulates a shadow cast by an objective lens end of the sight accessory.

An aspect of this disclosure provides a data processing apparatus, including processing circuitry. The processing circuitry is configured to display a first scene image of the virtual scene from a perspective of a controllable virtual character. The processing circuitry is configured to receive an input to utilize a sight accessory on a virtual weapon held by the controllable virtual character. The processing circuitry is configured to display a second scene image of the virtual scene as viewed through the sight accessory, the second scene image including an outline of the sight accessory. The processing circuitry is configured to render, within an inner region of the outline, an eyepiece shadow and an objective lens shadow. The eyepiece shadow simulates a shadow cast by an eyepiece end of the sight accessory, and the objective lens shadow simulates a shadow cast by an objective lens end of the sight accessory.

An aspect of this disclosure provides a non-transitory computer-readable storage medium storing instructions which when executed by a processor cause the processor to perform any of the methods of this disclosure.

The technical solutions provided in the embodiments of this disclosure can have the following beneficial effects.

By adding two shadows, namely the eyepiece end shadow and the objective lens end shadow, to an inner ring of an outline of the sight accessory on the virtual item, a player can view a more realistic image when controlling the current master virtual object to open the sight accessory and switch an observation angle, so that the virtual item in the virtual scene shows an effect in a real scene, making performance of the lens of the sight accessory richer, thereby enhancing an immersive experience when the player controls the current master virtual object to perform shooting, and also improving accuracy when the player performs shooting by using the sight accessory.

### BRIEF DESCRIPTION OF THE DRAWINGS

FIG. 1 is a schematic diagram of a virtual item display method according to an embodiment.

FIG. 2 is a schematic diagram of an outline shadow on a sight accessory when a location of the sight accessory is fixed at a screen center according to an embodiment.

FIG. 3 is a schematic diagram of changes in an eyepiece end shadow, an objective lens end shadow, and an outline shadow on a sight accessory when a location of the sight accessory is not fixed according to an embodiment.

FIG. 4 is a structural block diagram of a terminal according to an embodiment.

FIG. 5 is a schematic diagram of an implementation environment according to an embodiment.

FIG. 6 is a flowchart of a virtual item display method according to an embodiment.

FIG. 7 is a flowchart of a method for adding an eyepiece end shadow and an objective lens end shadow based on a sight accessory shown in FIG. 6.

FIG. 8 is an overall schematic diagram of an eyepiece end shadow according to another embodiment.

FIG. 9 is a schematic diagram of a part of an eyepiece end shadow on an inner ring of an outline of a sight accessory according to another embodiment.

FIG. 10 is an overall schematic diagram of an objective lens end shadow according to another embodiment.

FIG. 11 is a schematic diagram of a part of an objective lens end shadow on an inner ring of an outline of a sight accessory according to another embodiment.

FIG. 12 is a schematic diagram of a candidate lens display area according to another embodiment.

FIG. 13 is a schematic diagram of adding an outline shadow based on a lens display area according to another embodiment.

FIG. 14 is a flowchart of a virtual item display method in a case in which a breathing shake is superimposed according to another embodiment.

FIG. 15 is a schematic diagram of a virtual item display method according to another embodiment.

FIG. 16 is a schematic diagram of aiming down sight display content according to an embodiment.

FIG. 17 is a flowchart of a shadow display determining method according to another embodiment.

FIG. 18 is a structural block diagram of a virtual item display apparatus according to an embodiment.

FIG. 19 is a structural block diagram of a virtual item display apparatus according to another embodiment.

FIG. 20 is a structural block diagram of a computer device according to an embodiment.

### DESCRIPTION OF EMBODIMENTS

In embodiments of this disclosure, for a problem of a poor sense of reality of a lens image of a sight in a process in which a virtual object performs shooting through a sight accessory, two shadows, namely an eyepiece end shadow and an objective lens end shadow, are added on an inner ring of an outline of a sight accessory. After opening the sight accessory, as an aiming down sight animation plays on a terminal screen or a location of the sight accessory changes, a changing process of the eyepiece end shadow and the objective lens end shadow at different moments may be viewed, making performance of the lens of the sight accessory richer, thereby improving the sense of reality of the image, and also enhancing an immersive experience of a player when controlling a current master virtual object to perform shooting.

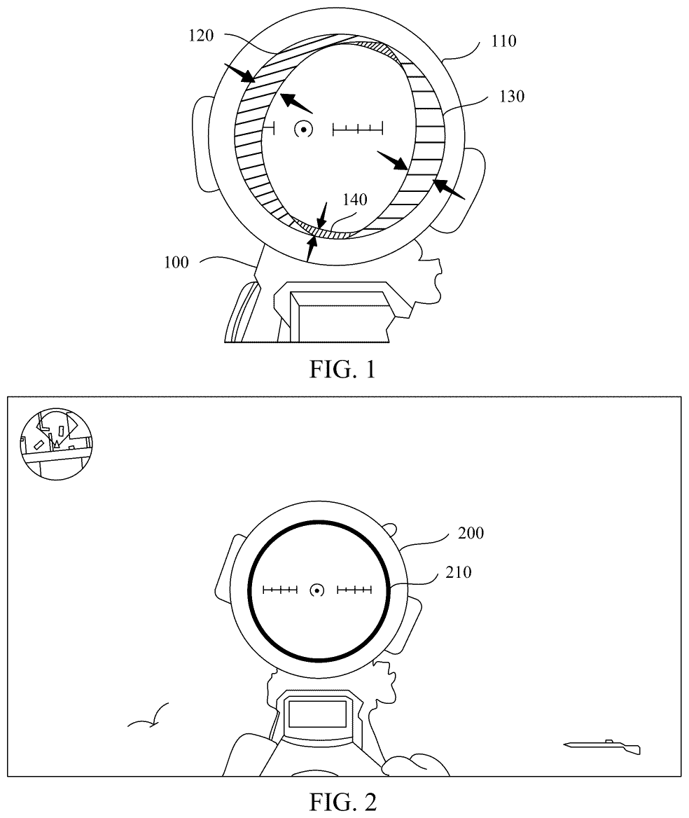

For example, as shown in FIG. 1, a virtual gun 100 used by a current master virtual object is equipped with a sight accessory 110. After the current master virtual object is controlled to open the sight accessory 110, an aiming down sight animation is automatically played on a screen. The aiming down sight animation includes the sight accessory 110 and an animation of shadow changes in the sight accessory 110. As shown in FIG. 1, it may be learnt that three types of shadows, namely, an eyepiece end shadow 120, an objective lens end shadow 130, and an outline shadow 140, are displayed on a lens of the sight accessory 110.

When a location of the sight accessory is fixed at a screen center, a front sight of the sight accessory coincides with the screen center. The objective lens end shadow and the eyepiece end shadow are not clearly displayed on the sight accessory, while the outline shadow is more clear. For example, FIG. 2 shows a display image of an outline shadow 210 on a sight accessory 200 when a location of the sight accessory 200 is fixed at a screen center.

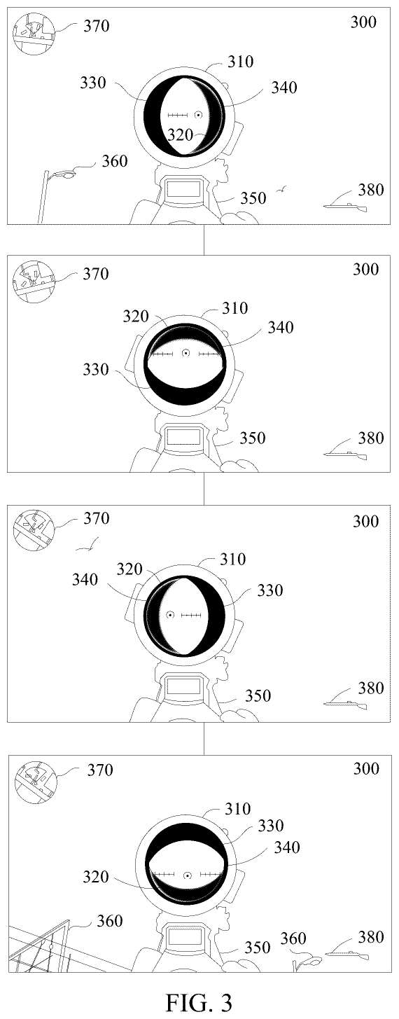

When the location of the sight accessory is not fixed, the eyepiece end shadow, the objective lens end shadow, and the outline shadow vary with the location of the sight accessory. For example, FIG. 3 is a schematic diagram in which after being opened, a sight accessory 310 changes a location in a counterclockwise direction, and an eyepiece end shadow 320, an objective lens end shadow 330, and an outline shadow 340 vary with the location of the sight 310.

After a current master virtual object is controlled to tap an aiming down sight key, the sight accessory 310 is opened, and a viewing angle of the current master virtual object is switched from a first observation range to a second observation range 300. The second observation range 300 includes contents such as a sight accessory 310, an eyepiece end shadow 320, an objective lens end shadow 330, an outline shadow 340, a virtual gun 350, a building 360, a virtual map 370, and a virtual gun flag 380.

The building 360 is a building in a virtual scene in which the current master virtual object is located, constitutes an image of the current virtual scene, and serves as identification information to indicate a user to control the current virtual object to perform actions at different locations in the virtual scene.

The virtual map 370 in an upper left corner refers to a location in the virtual scene in which the current master virtual object is located, represents that an observation range from a current viewing angle belongs to a specific part of the virtual scene, and serves as identification information to indicate the user to control the current virtual object to find information such as a specific location or coordinates of the current virtual object in the virtual scene. The virtual gun flag 380 in a lower right corner means that the current master virtual object is using the virtual gun 350.

As a location of the sight accessory 310 changes, that is, moves in a counterclockwise direction, locations of the eyepiece end shadow 320, the objective lens end shadow 330, and the outline shadow 340 also rotate in a counterclockwise direction along a lens outline of the sight accessory 310.

Because the location of the sight accessory 310 changes, the second observation range 300 observed through the sight accessory 310 also changes, that is, an image observed at a location in the current virtual scene changes.

The terminal in this application may be a desktop computer, a portable laptop computer, a mobile phone, a tablet computer, an ebook reader, a Moving Picture Experts Group Audio Layer III (MP3) player, a Moving Picture Experts Group Audio Layer IV (MP4) player, or the like. An application supporting a virtual scene is installed and run on the terminal, such as an application supporting a three-dimensional virtual scene. The application may be any one of a virtual reality application, a three-dimensional map program, a third-person shooting (TPS) game, a first-person shooting (FPS) game, and a multiplayer online battle arena (MOBA) game. In some embodiments, the application may be a standalone application, such as a standalone three-dimensional game, or may be a network online application.

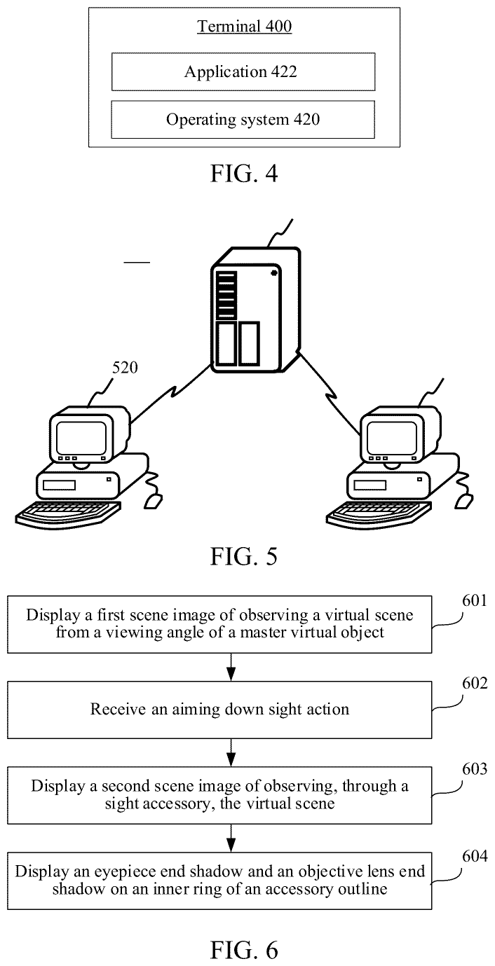

FIG. 4 is a structural block diagram of an electronic device according to an embodiment of this disclosure. The electronic device 400 includes an operating system 420 and an application 422.

The operating system 420 is basic software provided for the application 422 to perform secure access to computer hardware.

The application 422 is an application supporting a virtual scene. In some embodiments, the application 422 is an application supporting a three-dimensional virtual scene. The application 422 may be any one of a virtual reality application, a three-dimensional map program, a TPS game, an FPS game, and a MOBA game. In some embodiments, the application 422 may be a standalone application, such as a standalone three-dimensional game, or may be a network online application.

FIG. 5 is a structural block diagram of a computer system according to an embodiment of this disclosure. The computer system 500 includes a first device 520, a server 540, and a second device 560.

An application supporting a virtual scene is installed and run on the first device 520. The application may be any one of a virtual reality application, a three-dimensional map program, a TPS game, an FPS game, and a MOBA game. The first device 520 is a device used by a first user. The first user controls a second virtual object in the virtual scene by using the first device 520 to perform an action. The action includes, but is not limited to, at least one of body posture adjustment, crawling, walking, running, cycling, jumping, driving, picking, shooting, attacking, and throwing. For example, the second virtual object is a first virtual character such as a simulated character role or a cartoon character role.

The first device 520 is connected to the server 540 by using a wireless network or a wired network.

The server 540 includes at least one of one server, a plurality of servers, a cloud computing platform, and a virtualization center. The server 540 is configured to provide a back-end service for an application supporting a three-dimensional virtual scene. In some embodiments, the server 540 takes on primary computing work, the first device 520 and the second device 560 take on secondary computing work; alternatively, the server 540 takes on the secondary computing work, and the first device 520 and the second device 560 take on the primary computing work; alternatively, collaborative computing is performed by using a distributed computing architecture among the server 540, the first device 520, and the second device 560.

An application supporting a virtual scene is installed and run on the second device 560. The application may be any one of a virtual reality application, a three-dimensional map program, an FPS game, and a MOBA game. The second device 560 is a device used by a second user. The second user controls a second virtual object in a virtual scene by using the second device 560 to perform an action. The action includes, but is not limited to, at least one of body posture adjustment, crawling, walking, running, cycling, jumping, driving, picking, shooting, attacking, and throwing. For example, the second virtual object is a second virtual character such as a simulated character role or a cartoon character role.

In some embodiments, the first virtual character and the second virtual character are located in the same virtual scene. In some embodiments, the first virtual character and the second virtual character may belong to the same team or the same organization, have a friend relationship, or have a temporary communication permission. In some embodiments, the first virtual character and the second virtual character may alternatively belong to different teams, different organizations, or two groups hostile to each other.

In some embodiments, the applications installed on the first device 520 and the second device 560 are the same, or the applications installed on the two devices are the same type of applications of different control system platforms. The first device 520 may refer to one of a plurality of devices, the second device 560 may refer to one of a plurality of devices, and in this embodiment, description is made by using only the first device 520 and the second device 560 as an example. The type of the first device 520 and the type of the second device 560 may be the same or may be different. The device type includes at least one of a game console, a desktop computer, a smartphone, a tablet computer, an ebook reader, an MP3 player, an MP4 player, and a laptop computer. In the following embodiments, description is made by using an example in which the device is a desktop computer.

The server 540 may be implemented as a physical server, or may be implemented as a cloud server in the cloud. In some embodiments, the server 540 may alternatively be implemented as a node in a blockchain system.

In some embodiments, the method provided in the embodiments of this disclosure may be applied to a cloud game scene, so that calculation of data logic in a game process is completed through the cloud server, and a terminal is responsible for displaying a game interface.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

With reference to the foregoing noun introduction and an implementation environment description, the virtual item display method provided in the embodiments of this disclosure is described. FIG. 6 is a flowchart of a virtual item display method according to an embodiment of this disclosure. An example in which the method is applied to a terminal is used for description. As shown in FIG. 6, the method includes the following steps.

Step 601: Display a first scene image of observing a virtual scene from a viewing angle of a master virtual object. For example, a first scene image of the virtual scene is displayed from a perspective of a controllable virtual character.

The first scene image includes but is not limited to contents such as a current master virtual object, a virtual building in a current virtual scene, and a virtual item used by the current master virtual object.

In some embodiments, an example in which the master virtual object is a current master virtual object of a terminal is used. The current master virtual object is located in the virtual scene, that is, currently, the terminal may control the master virtual object to perform various actions or perform various events in the virtual scene.

In some embodiments, a virtual item held by the master virtual object is a virtual gun. The virtual gun is equipped with a sight accessory, and the sight accessory includes an eyepiece end and an objective lens end.

In some embodiments, the sight accessory is an accessory configured to assist the master virtual object in adjusting a shooting field of view, which includes at least one of a telescopic sight, a reflective sight, and a collimation sight.

In some embodiments, the virtual scene includes the master virtual object and an enemy virtual object, that is, the virtual scene includes the current master virtual object and the enemy virtual object. The current master virtual object performs a shooting event in the virtual scene, that is, the master virtual object shoots the enemy virtual object by using the virtual gun. In the shooting process, the sight accessory on the virtual gun may be used to assist in targeting the enemy virtual object.

In addition to the master virtual object, the virtual scene may include other virtual objects. The other virtual objects include an enemy virtual object of the master virtual object, the other virtual objects include a teammate virtual object of the master virtual object, or the other virtual objects include a teammate virtual object and an enemy virtual object of the master virtual object. In some embodiments, the other virtual objects further include a duplicated virtual object of the master virtual object, that is, the duplicated virtual object and the master virtual object correspond to the same object parameter, but correspond to different scene locations. This is not limited in this embodiment. Types of the virtual item include but are not limited to a virtual gun, a virtual bullet, a virtual energy drink, a virtual medical device, and the like. This is not limited in this embodiment.

The virtual gun is a type of the virtual item. Types of virtual gun include but are not limited to a virtual submachine gun, a virtual submachine pistol, a virtual assault rifle, a virtual sniper rifle, a virtual light machine gun, a virtual shotgun, a virtual pistol, and a virtual launcher.

The virtual item used by the current master virtual object may be a virtual item of any type, and the virtual gun used by the master virtual object may be any one of the foregoing types of virtual gun. This is not limited in this embodiment.

In some embodiments, the sight accessory is an accessory assembled on the virtual gun, and is configured to allow a player to switch, when controlling the current master virtual object to perform a shooting event, an observation viewing angle through the sight accessory, to be specific, switch from a first observation range to a second observation range. The sight accessory is located on the virtual gun such as the virtual rifle, the virtual sniper rifle, or the virtual submachine gun.

Types of the sight accessory include but are not limited to a holographic sight, a red dot sight, a multiple sight, and the like. The multiple sight includes but is not limited to a sight accessory with different magnifications such as a 2× sight, a 3× sight, and a 4× sight. Different types of sight accessories are applicable to shooting cases with different distance ranges. This is not limited in this embodiment.

In some embodiments, the sight accessory assembled on the virtual gun of the master virtual object is the multiple sight.

The sight accessory includes but is not limited to components such as an objective lens end, an eyepiece end, and a lens barrel. The objective lens end plays a role of magnifying an observed target in a first step, that is, the objective lens end may magnify a distant target and form a corresponding real image. A main function of the eyepiece end may be transmitting an image, or re-magnifying the real image magnified by the objective lens end, thereby forming a clear virtual image at a location suitable for observation by human eyes normally. The lens barrel has a cylindrical structure. One end of the lens barrel is connected to the eyepiece end, and the other end of the lens barrel is connected to the objective lens end. The lens barrel is configured for mounting of a lens on the eyepiece end and a lens on the objective lens end, to assist in magnifying an object in an observation range.

A shape of the sight accessory may be arbitrary, and a type of the sight accessory may be arbitrary. When the sight accessory is a multiple sight, a multiple of the sight accessory may be arbitrary. The sight accessory may be located on any virtual item that may be equipped with the sight accessory. The sight accessory may include at least one of components such as an eyepiece, an objective lens, and a lens barrel. This is not limited in this embodiment.

Step 602: Receive an aiming down sight action. For example, an input is received to utilize a sight accessory on a virtual weapon held by the controllable virtual character.

The aiming down sight action refers to opening a sight accessory on the virtual gun used by the current master virtual object to observe the virtual scene.

In some embodiments, an example in which a terminal device is a mobile phone, a tablet computer, or the like is used. Starting of the aiming down sight action may be implemented by tapping an aiming down sight key on a screen. The aiming down sight key is tapped, to switch a viewing angle of the master virtual object to a viewing angle of observing, by using the sight accessory, the current virtual scene, that is, an observation range of the master virtual object is adjusted from a first observation range to a second observation range.

In some embodiments, an example in which the terminal device is a desktop computer, a notebook computer, or the like is used. Starting of the aiming down sight action may be implemented through a shortcut key. The shortcut key is pressed, and the observation range of the master virtual object is adjusted from the first observation range to the second observation range.

When the aiming down sight action starts, a corresponding aiming down sight animation is displayed on the screen, which is configured for displaying an entire process of the aiming down sight action. According to different aiming down sight percentages, images of the sight accessory in a process of the aiming down sight animation are also different. In other words, the aiming down sight animation includes contents such as changes in an opening degree of the sight accessory and changes in a location of the sight accessory, where the aiming down sight percentage is configured for describing the opening degree of the sight accessory. For example: when waist shooting is performed, an aiming down sight percentage is 0; when a sight is fully opened, an aiming down sight percentage is 1; and in a process of opening and closing a sight, an aiming down sight percentage smoothly transitions between 0 and 1.

The terminal device may be arbitrary, and a manner of starting the aiming down sight action may also be arbitrary. When the terminal device is a device such as the mobile phone, or the tablet computer, a manner of starting the aiming down sight action includes but is not limited to tapping the aiming down sight key, touching and holding the aiming down sight key, tapping the aiming down sight key a plurality of times, automatically opening the sight when shooting, or the like. When the terminal device is a device such as the desktop computer, or the notebook computer, a manner of starting the aiming down sight action includes but is not limited to pressing a shortcut key, clicking the aiming down sight key by using a mouse, or the like. When the terminal device is a device of another type, a manner of starting the aiming down sight action may also be arbitrary. This is not limited in this embodiment.

Step 603: Display a second scene image of observing, through the sight accessory, the virtual scene. For example, a second scene image of the virtual scene is displayed as viewed through the sight accessory, the second scene image including an outline of the sight accessory.

The second scene image is an image that the master virtual object views through the sight accessory on the virtual gun, and is an image displayed on the screen based on the virtual scene.

In some embodiments, the second scene image includes but is not limited to contents such as a virtual map corresponding to the virtual scene, an enemy virtual object, a sight accessory, an accessory outline corresponding to the sight accessory, a part of a joint between the virtual gun and the sight accessory, a virtual building, a virtual gun flag, a front sight of the sight accessory, and a center point of the screen.

The second scene image may include at least one of the foregoing contents, or may not include the foregoing contents. This is not limited in this embodiment.

A location targeted by the sight accessory is the front sight, which is configured to assist in targeting the enemy virtual object, and then perform, based on the front sight, an action of shooting the enemy virtual object. The front sight is located in a center of the eyepiece end of the sight accessory.

When performing a shooting event by using the virtual gun, the master virtual object may perform observation and assist in targeting the enemy virtual object by using the sight accessory, or may directly perform waist shooting without performing observation by using the sight accessory. This is not limited in this embodiment. Waist shooting is a shooting technique or shooting manner, that is, shooting is directly performed without opening the sight accessory. Because the sight is not opened, usually a deviation or shaking may occur when waist shooting is performed.

A location of the front sight may be arbitrary, and is determined by the location of the eyepiece end of the sight accessory. The location of the front sight may be the center of the eyepiece end of the sight accessory, or may deviate from the center of the eyepiece end of the sight accessory, but needs to be in a range of the eyepiece end of the sight accessory, that is, needs to be located in an accessory outline corresponding to the sight accessory. This is not limited in this embodiment.

Step 604: Display an eyepiece end shadow and an objective lens end shadow on an inner ring of an accessory outline. For example, an eyepiece shadow and an objective lens shadow is rendered within an inner region of the outline. In an example, the eyepiece shadow simulates a shadow cast by an eyepiece end of the sight accessory, and the objective lens shadow simulates a shadow cast by an objective lens end of the sight accessory.

The inner ring of the accessory outline usually refers to an accessory outline corresponding to a lens on the eyepiece end of the sight accessory. The lens of the sight accessory includes the lens on the eyepiece end and the lens on the objective lens end. Usually only the lens on the eyepiece end of the sight accessory is displayed on the screen, that is, the lens on an end closer to the human eyes corresponding to the current master virtual object.

In some embodiments, an outline ring of the sight accessory refers to the outline ring of the lens on the eyepiece end of the sight accessory.

An eyepiece end shadow refers to a shadow produced by the sight accessory on a lens barrel on the eyepiece end. The eyepiece end shadow means that when a location of the sight accessory moves, light in the virtual scene blocks a part of a location of the lens barrel of the sight accessory. As a result, a shadow is produced on the lens barrel on the eyepiece end. The eyepiece end shadow is configured for simulating a light effect in the virtual scene, and when the location of the sight accessory moves, displaying, on the screen, an image that the lens on the eyepiece end correspondingly changes.

An objective lens end shadow refers to a shadow produced by the sight accessory on a lens barrel on the objective lens end. The objective lens end shadow means that when a location of the sight accessory moves, light in the virtual scene blocks a part of a location of the lens barrel of the sight accessory. As a result, a shadow is produced on the lens barrel on the objective lens end. The objective lens end shadow is configured for simulating a light effect in the virtual scene, and when the location of the sight accessory moves, displaying, on the screen, an image that the lens on the objective lens end correspondingly changes.

The accessory outline of the sight accessory may be an accessory outline corresponding to the lens on the eyepiece end of the sight accessory, or may be an accessory outline corresponding to the lens on the objective lens end of the sight accessory that is mapped to the lens on the eyepiece end of the sight accessory, or may be a mapping outline, namely, a lens barrel outline, of the entire lens barrel of the sight accessory in a vertical direction of the human eyes corresponding to the current master virtual object. This is not limited in this embodiment.

In addition to the eyepiece end shadow and the objective lens end shadow of the sight accessory, there may be shadows, such as an outline shadow, produced in another manner on the sight accessory. The outline shadow is a shadow produced by the lens on the eyepiece end of the sight accessory being blocked by light. In other words, the shadow produced by the sight accessory includes but is not limited to at least any one of shadows such as an outline shadow, an eyepiece end shadow of the sight accessory, and an objective lens end shadow of the sight accessory. This is not limited in this embodiment.

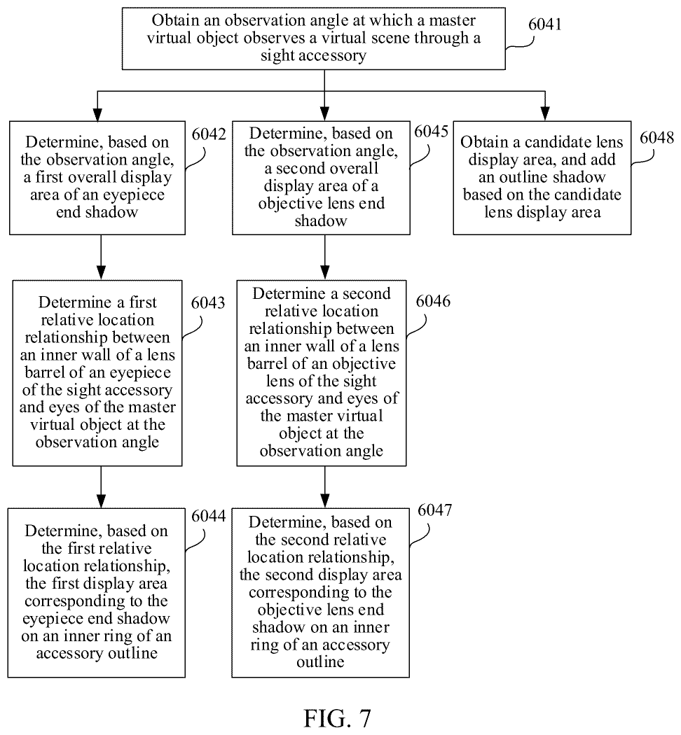

In an embodiment, an eyepiece end shadow and an objective lens end shadow are displayed on an inner ring of an outline of a sight accessory. As shown in FIG. 7, the foregoing step 604 may be further implemented as the following steps.

Step 6041: Obtain an observation angle at which the master virtual object observes, through the sight accessory, the virtual scene. For example, an observation angle of the controllable virtual character is determined when viewing through the sight accessory.

In some embodiments, the observation angle at which the master virtual object observes, through the sight accessory, the virtual scene is a first preset observation angle, and human eyes of the master virtual object face the sight accessory.

Because the sight accessory is a part of the virtual gun held by the master virtual object, when the virtual gun changes a location on the screen according to factors such as gun swing, the location of the sight accessory also varies with the location of the virtual gun. In other words, when the master virtual object performs observation through the sight accessory, an observation angle of the master virtual object also changes. The observation angle of the master virtual object may be arbitrary. This is not limited in this embodiment.

Step 6042: Determine, based on the observation angle, a first overall display area of the eyepiece end shadow. For example, a first display area is determined based on the observation angle corresponding to the eyepiece shadow.

After the aiming down sight key on the screen is tapped, the master virtual object switches from a current viewing angle to a viewing angle of performing observation by using the sight accessory, that is, the first observation range of the master virtual object is switched to the second observation range.

In some embodiments, the master virtual object performs observation through the sight accessory based on a first preset observation angle.

In some embodiments, the first overall display area of the eyepiece end shadow is a circular area, and an area of the first overall display area is slightly greater than an area of the eyepiece lens of the sight accessory.

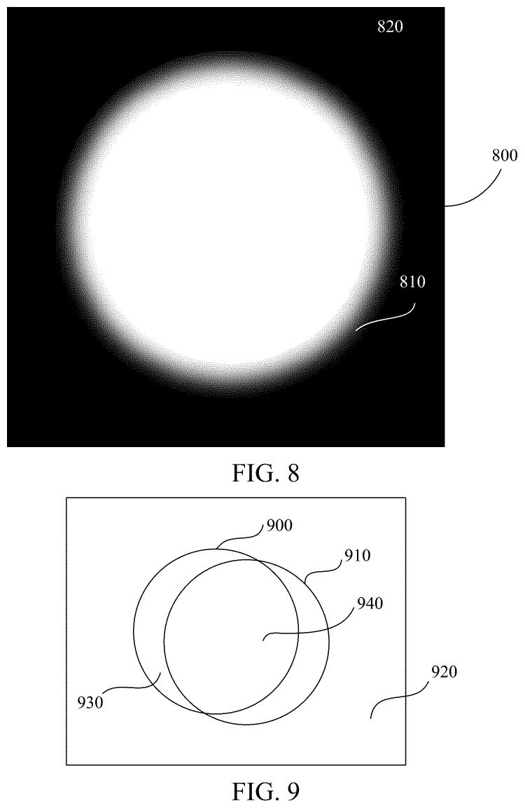

For example, FIG. 8 is an overall schematic diagram of an eyepiece end shadow. As shown in FIG. 8, there is a black rectangular area 800 in the figure, and in the middle of the black rectangular area 800, there is a white circular area 810 with a preset center location as a center and a preset length as a radius.

A remaining black area 820 is a shadow part of an eyepiece end, and the white circular area 810 is a visible area of the eyepiece end, that is, the white circular area is a first overall display area of the eyepiece end shadow.

A location of a sight accessory may be changed to any location, that is, an observation angle at which the master virtual object performs observation through the sight accessory may be arbitrary. This is not limited in this embodiment.

The first overall display area of the eyepiece end shadow may be of any shape, including but not limited to shapes such as a circle, a rectangle, and an irregular graphic, but a center of the first overall display area of the eyepiece end shadow is a front sight of the sight accessory.

The eyepiece end shadow part may be of any shape, including but not limited to shapes such as a circle, a rectangle, and an irregular graphic, and the first overall display area of the eyepiece end shadow may be located at any location in the eyepiece end shadow part. An area of the first overall display area may be arbitrary, that is, the area of the first overall display area may be slightly greater than an area of the eyepiece lens of the sight accessory, or may be equal to an area of the eyepiece lens of the sight accessory, or may be slightly less than an area of the eyepiece lens of the sight accessory. This is not limited in this embodiment.

Step 6043: Determine a first relative location relationship, at the observation angle, between an inner wall of a lens barrel of an eyepiece of the sight accessory and eyes of the master virtual object. For example, a first spatial relationship is determined between an inner wall of the eyepiece end and a viewpoint of the controllable virtual character at the observation angle.

The eyepiece end shadow observed by eyes of the master virtual object at the first preset observation angle is formed by an inner wall of a lens barrel of an eyepiece of the sight accessory being blocked by light in a virtual scene, that is, the eyepiece end shadow is caused by the lens barrel of the eyepiece of the sight accessory.

In some embodiments, a preset center location of the eyepiece end shadow is located at the lower right of the screen center, and a distance between the preset center location of the eyepiece end shadow and the screen center is not greater than 2 mm.

In some embodiments, an image observed by the eyes of the master virtual object at the first preset observation angle includes the eyepiece lens of the sight accessory, the first overall display area of the eyepiece end shadow, and the eyepiece end shadow part.

In some embodiments, there is an overlapping relationship between the first overall display area of the eyepiece end shadow and the eyepiece lens of the sight accessory. That is, the first overall display area of the eyepiece end shadow partially overlaps with the eyepiece lens of the sight accessory. That is, a first relative location relationship, at the observation angle, between the inner wall of the lens barrel of the eyepiece of the sight accessory and the eyes of the master virtual object is the overlapping relationship.

The preset center location of the eyepiece end shadow may be arbitrary. The preset center location of the eyepiece end shadow may coincide with the screen center. The preset center location of the eyepiece end shadow may also not coincide with the screen center. However, the preset center location of the eyepiece end shadow needs to be located in a screen range. If the preset center location of the eyepiece end shadow does not coincide with the screen center, the distance between the preset center location of the eyepiece end shadow and the screen center may be any legal distance. This is not limited in this embodiment.

The image observed by the eyes of the master virtual object at the first preset observation angle includes but is not limited to at least one content of the eyepiece lens of the sight accessory, the first overall display area of the eyepiece end shadow, and the eyepiece end shadow part. The image observed by the eyes of the master virtual object at the first preset observation angle may also include other contents, such as an enemy virtual object. This is not limited in this embodiment.

There may be or may not be an overlapping relationship between the first overall display area of the eyepiece end shadow and the eyepiece lens of the sight accessory. That is, the first relative location relationship, at the observation angle, between the inner wall of the lens barrel of the eyepiece of the sight accessory and the eyes of the master virtual object may be or may not be the overlapping relationship. If the first relative location relationship is the overlapping relationship, the first overall display area of the eyepiece end shadow may partially overlap with or completely overlap with the eyepiece lens of the sight accessory. This is not limited in this embodiment.

Step 6044: Determine, based on the first relative location relationship, the first display area corresponding to the eyepiece end shadow on the inner ring of the accessory outline. For example, the first display area is determined based on the first spatial relationship.

The accessory outline ring refers to an outline ring of the eyepiece lens of the sight accessory.

In some embodiments, the first relative location relationship is the overlapping relationship, that is, the first overall display area of the eyepiece end shadow partially overlaps with the eyepiece lens of the sight accessory.

For example, FIG. 9 is a schematic diagram of a part of an eyepiece end shadow on an inner ring of an outline of a sight accessory. As shown in FIG. 9, there is an overlapping relationship between a first overall display area 910 on an eyepiece end and an eyepiece lens 900 of a sight accessory, that is, there is a first display area 940. An image that is viewed when a master virtual object performs observation through the sight accessory is located in the first display area 940.

There is a first overlapping area 930 between the eyepiece lens 900 of the sight accessory and a shadow part 920 on the eyepiece end. The first overlapping area 930 is a part of the eyepiece end shadow on the inner ring of the outline of the sight accessory. That is, the first overlapping area 930 is also a shadow.

A first relative location relationship may be or may not be the overlapping relationship, where the overlapping relationship includes a coincidence relationship. If the first relative location relationship is the overlapping relationship, the first display area is an area in which the first overall display area on the eyepiece end coincides with the eyepiece lens of the sight accessory. If the first relative location relationship is not the overlapping relationship, there is no first display area. This is not limited in this embodiment.

Step 6045: Determine, based on the observation angle, a second overall display area of the objective lens end shadow. For example, a second display area is determined based on the observation angle corresponding to the objective lens shadow within the inner region of the outline.

After the aiming down sight key on the screen is tapped, the master virtual object switches from a current viewing angle to a viewing angle of performing observation by using the sight accessory, that is, the first observation range of the master virtual object is switched to the second observation range.

In some embodiments, the master virtual object observes a virtual scene through the sight accessory based on a first preset observation angle.

In some embodiments, a second overall display area of an objective lens end shadow is a circular area, and an area of the second overall display area is slightly greater than an area of the eyepiece lens of the sight accessory.

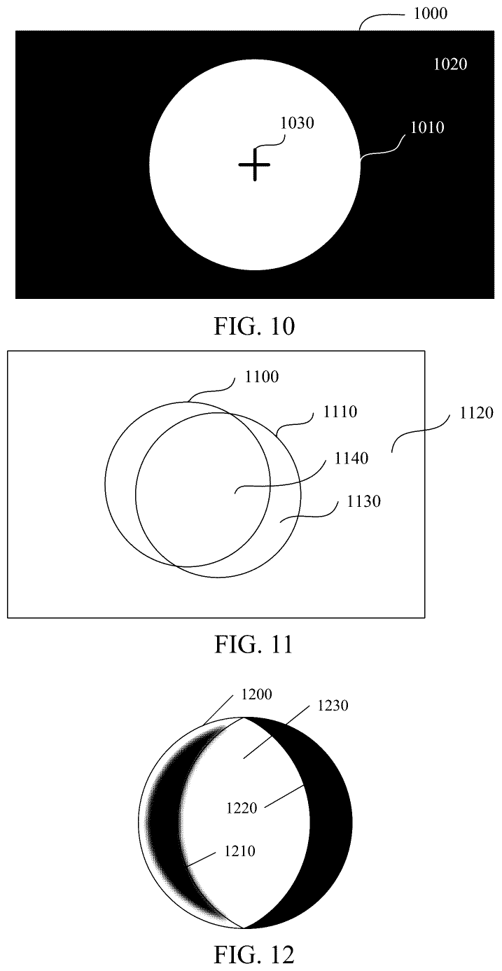

For example, FIG. 10 is an overall schematic diagram of an objective lens end shadow. As shown in FIG. 10, there is a black rectangular area 1000 in the figure, and in the middle of the black rectangular area 1000, there is a white circular area 1010 with a front sight 1030 as a center and a preset length as a radius.

A center of the white circular area 1010 is a flag of the front sight 1030, a remaining black area 1020 is a shadow part of an objective lens end, and the white circular area 1010 is a visible area of the objective lens end. That is, the white circular area is a second overall display area of an objective lens end shadow.

A location of a sight accessory may be changed to any location, that is, an observation angle at which a master virtual object performs observation through the sight accessory may be arbitrary. This is not limited in this embodiment.

The second overall display area of the objective lens end shadow may be of any shape, including but not limited to shapes such as a circle, a rectangle, and an irregular graphic, but a center of the second overall display area of the objective lens end shadow is a front sight of the sight accessory.

The objective lens end shadow part may be of any shape, including but not limited to shapes such as a circle, a rectangle, and an irregular graphic, and the second overall display area of the objective lens end shadow may be located at any location in the objective lens end shadow part. An area of the second overall display area may be arbitrary, that is, the area of the second overall display area may be slightly greater than an area of the eyepiece lens of the sight accessory, or may be equal to an area of the eyepiece lens of the sight accessory, or may be slightly less than an area of the eyepiece lens of the sight accessory. This is not limited in this embodiment.

Step 6046: Determine a second relative location relationship, at the observation angle, between an inner wall of a lens barrel of an objective lens of the sight accessory and the eyes of the master virtual object. For example, a second spatial relationship is determined between an inner wall of the objective lens end and the viewpoint of the controllable virtual character at the observation angle.

The objective lens end shadow observed by eyes of the master virtual object at the first preset observation angle is formed by an inner wall of a lens barrel of an objective lens of the sight accessory being blocked by light in a virtual scene, that is, the objective lens end shadow is caused by the lens barrel of the objective lens of the sight accessory.

In some embodiments, a front sight of the sight accessory is located at the bottom right of a screen center, and a distance between the front sight of the sight accessory and the screen center is not greater than 2 mm.

In some embodiments, an image observed by the eyes of the master virtual object at the first preset observation angle includes the eyepiece lens of the sight accessory, the second overall display area of the objective lens end shadow, and the objective lens end shadow part.

In some embodiments, there is an overlapping relationship between the second overall display area of the objective lens end shadow and the eyepiece lens of the sight accessory. That is, the second overall display area of the objective lens end shadow partially overlaps with the eyepiece lens of the sight accessory. That is, a second relative location relationship, at the observation angle, between the inner wall of the lens barrel of the objective lens of the sight accessory and the eyes of the master virtual object is the overlapping relationship.

A front sight location of the sight accessory may be arbitrary, and the front sight location of the sight accessory varies with the location of the sight accessory. The front sight location of the sight accessory may coincide with the screen center. The front sight of the sight accessory may also not coincide with the screen center. However, the front sight location needs to be located in a screen range. If the front sight of the sight accessory does not coincide with the screen center, a distance between the front sight of the sight accessory and the screen center may be any legal distance. This is not limited in this embodiment.

The image observed by the eyes of the master virtual object at the first preset observation angle includes but is not limited to at least one content of the eyepiece lens of the sight accessory, the second overall display area of the objective lens end shadow, and the objective lens end shadow part. The image observed by the eyes of the master virtual object at the first preset observation angle may also include other contents, such as an enemy virtual object. This is not limited in this embodiment.

There may be or may not be an overlapping relationship between the second overall display area of the objective lens end shadow and the eyepiece lens of the sight accessory. That is, the second relative location relationship, at the observation angle, between the inner wall of the lens barrel of the objective lens of the sight accessory and the eyes of the master virtual object may be or may not be the overlapping relationship. If the second relative location relationship is the overlapping relationship, the second overall display area of the objective lens end shadow may partially overlap with or completely overlap with the eyepiece lens of the sight accessory. This is not limited in this embodiment.

Step 6047: Determine, based on the second relative location relationship, the second display area corresponding to the objective lens end shadow on the inner ring of the accessory outline. For example, the second display area is determined based on the second spatial relationship.

The accessory outline ring refers to an outline ring of the eyepiece lens of the sight accessory.

In some embodiments, the second relative location relationship is the overlapping relationship, that is, the second overall display area of the objective lens end shadow partially overlaps with the eyepiece lens of the sight accessory.

For example, FIG. 11 is a schematic diagram of a part of an objective lens end shadow on an inner ring of an outline of a sight accessory. As shown in FIG. 11, there is an overlapping relationship between a second overall display area 1100 on an objective lens end and an eyepiece lens 1110 of a sight accessory, that is, there is a second display area 1140. An image that is viewed when a master virtual object performs observation through the sight accessory is located in the second display area 1140.

There is a second overlapping area 1130 between the eyepiece lens 1110 of the sight accessory and a shadow part 1120 on the objective lens end. The second overlapping area 1130 is a part of the objective lens end shadow on the inner ring of the outline of the sight accessory. That is, the second overlapping area 1130 is also a shadow.

A second relative location relationship may be or may not be the overlapping relationship, where the overlapping relationship includes a coincidence relationship. If the second relative location relationship is the overlapping relationship, the second display area is an area in which the second overall display area on the objective lens end coincides with the eyepiece lens of the sight accessory. If the second relative location relationship is not the overlapping relationship, there is no second display area. This is not limited in this embodiment.

The operations performed in step 6042 to step 6044 are parallel to the operations performed in step 6045 to step 6047. That is, the operations performed in step 6042 to step 6044 and the operations performed in step 6045 to step 6047 are simultaneously performed. That is, after step 6041 is performed, the operations performed in step 6042 to step 6044 and the operations performed in step 6045 and step 6046 are simultaneously performed.

After the foregoing steps are performed, step 6048 continues to be performed.

Step 6048 may be performed before step 6042 to step 6044 and step 6045 to step 6047 are performed. Step 6048 may also be performed after step 6042 to step 6044 and step 6045 to step 6047 are performed. Step 6048 may also be simultaneously performed with step 6042 to step 6044 and step 6045 to step 6047. This is not limited in this embodiment.

Step 6048: Obtain a candidate lens display area, and display an outline shadow based on the candidate lens display area. For example, a candidate lens display area is determined. In an example, the candidate lens display area is a light-transmitting region of the sight accessory. In another example, an outline shadow is rendered based on the candidate lens display area. For example, the outline shadow simulates a shadow cast by an edge of a lens of the sight accessory based on light in the virtual scene.

The candidate lens display area refers to a light-transmitting area corresponding to the sight accessory, which is configured for displaying an image part that the master virtual object can view when performing, by using the sight accessory, observation.

The outline shadow is a shadow produced by a lens of the sight accessory being blocked by light in the virtual scene.

In some embodiments, the candidate lens display area is an area displayed by the eyepiece lens of the sight accessory.

Based on step 6041 to step 6047, a part of the eyepiece end shadow on the inner ring of the sight accessory outline and a part of the objective lens end shadow on the inner ring of the outline of the sight accessory may be obtained, namely, the first overlapping area and the second overlapping area.

A preset black edge shadow is superimposed on an inner ring of the candidate lens display area, and an area in a preset black edge shadow range is used as a lens display area.

In some embodiments, the preset black edge shadow is separately superimposed on the first overlapping area and the second overlapping area.
1. A first black edge shadow is superimposed on the first overlapping area, where the first black edge shadow is blurry.
2. A second black edge shadow is superimposed on the second overlapping area, where the second black edge shadow is clear.

For example, FIG. 12 is a schematic diagram of a candidate lens display area. As shown in FIG. 12, in the candidate lens display area 1200, a first black edge shadow 1210 and a second black edge shadow 1220 are superimposed, and a remaining part on which a preset shadow is not superimposed is a lens display area 1230.

In some embodiments, an outline shadow is added based on the lens display area. A size and a shape of the outline shadow are the same as a size and a shape of a lens of a sight accessory.

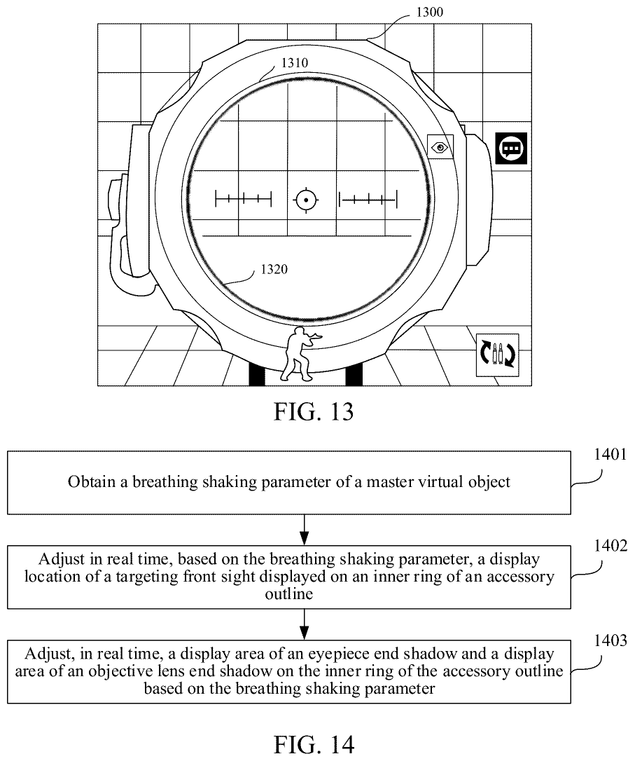

The master virtual object performs observation by using the sight accessory, and switches a viewing angle from a first observation range to a second observation range. For example, FIG. 13 is a schematic diagram of adding an outline shadow based on a lens display area. As shown in FIG. 13, human eyes of a master virtual object face a sight accessory 1300, and the sight accessory 1300 is at a preset front location. In this case, an eyepiece end shadow and an objective lens end shadow in the sight accessory 1300 exist, but are not obvious.

The master virtual object performs observation through the sight accessory 1300, and may view content in a lens display area 1310. Along a shape of the lens display area 1310, an outline shadow 1320 is added on an inner side of the lens display area 1310. A size of the outline shadow 1320 may be considered to be the same as a size of the lens display area 1310.

The human eyes of the master virtual object may directly face the sight accessory, or may be located at another relative location of the sight accessory. The sight accessory may be located at any location on a screen. A front surface display degree of a lens of the sight accessory may be arbitrary, that is, a front surface or a side surface of the lens of the sight accessory may be displayed on the screen. This is not limited in this embodiment.

The eyepiece end shadow and the objective lens end shadow in the sight accessory always exist, and a location of the eyepiece end shadow and a location of the objective lens end shadow vary with a location of the sight accessory on the screen. Coverage of the eyepiece end shadow and coverage of the objective lens end shadow also vary with the location of the sight accessory on the screen. A size of the outline shadow may be arbitrary, but needs to be along the lens of the sight accessory, and a shape of the outline shadow depends on a shape of the lens of the sight accessory. The shape of the lens of the sight accessory may be arbitrary. This is not limited in this embodiment.

In summary, in the method provided in this embodiment of this disclosure, the eyepiece end shadow and the objective lens end shadow are added to an inner ring of an outline of the sight accessory, and an outline shadow is added inside an outline of the lens of the sight accessory. After opening the sight accessory, the master virtual object performs observation through the sight accessory. As an aiming down sight animation plays on a terminal screen or a location of the sight accessory changes, a changing process of the eyepiece end shadow and the objective lens end shadow at different moments may be viewed, making performance of the lens of the sight accessory richer, thereby improving the sense of reality of the image, and also enhancing an immersive experience of a player when controlling a current master virtual object to perform shooting.

In the method provided in this embodiment of this disclosure, two display areas, namely, the first display area corresponding to the eyepiece end shadow and the second display area corresponding to the objective lens end shadow, in the sight accessory are obtained based on an observation angle at which the master virtual object performs observation through the sight accessory. A part in the outline of the sight accessory on which a shadow needs to be superimposed is found, so that the performance of the lens of the sight accessory is closer to a real aiming down sight image, and a process in which the player performs aiming down sight and shooting in the virtual scene is more consistent with an actual aiming down sight and shooting process, thereby improving accuracy of shooting.

In the method provided in this embodiment of this disclosure, the observation angle at which the master virtual object observes the virtual scene by using the sight accessory is obtained, and a first relative location relationship between the eyes of the master virtual object and a lens barrel of the eyepiece of the sight accessory and a second relative location relationship between the eyes of the master virtual object and a lens barrel of the objective lens of the sight accessory are further obtained. In this way, a display area is more in line with a viewing angle range observed by the eyes. In addition, a part in the outline of the sight accessory on which a shadow needs to be superimposed may be further found based on the first relative location relationship and the second relative location relationship, so that the shadow is superimposed in a more accurate manner, and a display effect on the screen is better.

In the method provided in this embodiment of this disclosure, an overlapping relationship between the lens display area of the sight accessory and an eyepiece penetration area is determined through the first relative location relationship, so that the first display area corresponding to the eyepiece end shadow is further determined. The part in the outline of the sight accessory on which the eyepiece end shadow needs to be superimposed may be further found based on the first display area, so that a superimposition effect of the eyepiece end shadow has a greater sense of reality.

In the method provided in this embodiment of this disclosure, an overlapping relationship between the lens display area of the sight accessory and an objective lens penetration area is determined through the second relative location relationship, so that the second display area corresponding to the objective lens end shadow is further determined. The part in the outline of the sight accessory on which the objective lens end shadow needs to be superimposed may be further found based on the second display area, so that a superimposition effect of the objective lens end shadow has a greater sense of reality.

In the method provided in this embodiment of this disclosure, a preset black edge shadow is superimposed based on obtaining a candidate lens display area, so that an area in a preset black edge shadow range is used as the lens display area, and an edge of the lens also has physical characteristics in the virtual scene, and is no longer a two-dimensional concept, thereby improving display reality of the lens display area.

In the method provided in this embodiment of this disclosure, based on a case in which the objective lens end shadow and the eyepiece end shadow are added to the sight accessory, the outline shadow continues to be superimposed. In addition, a final display image of the sight accessory on the screen is determined according to the three shadows, and an image range that the master virtual object can view when performing, through the sight accessory, observation is determined, making performance of the lens of the sight accessory richer, thereby improving the sense of reality of the image, and also enhancing an immersive experience of a player when controlling a current master virtual object to perform shooting.

FIG. 14 is a flowchart of a virtual item display method in a case in which a breathing shake is superimposed according to another embodiment of this disclosure. The following steps are included.

Step 1401: Obtain a breathing shaking parameter of a master virtual object. For example, a breathing simulation parameter is obtained for the controllable virtual character. In an example, the breathing simulation parameter is a simulated shaking effect when the controllable virtual character holds the virtual weapon.

A breathing shake is configured for simulating a case in which a virtual item held by the master virtual object shakes due to breathing of the master virtual object. The breathing shaking parameter is a random value in a two-dimensional direction, and may be preset in advance. An amplitude of the breathing shake is usually low, that is, a value of the breathing shaking parameter is small.

For example, the virtual item held by the master virtual object is a virtual gun. The virtual gun is equipped with a sight accessory. Affected by the breathing shake, the virtual gun shakes with the breathing of the master virtual object. The sight accessory on the virtual gun also shakes as the virtual gun shakes. Therefore, a front sight of the sight accessory is also affected by the breathing shake.

A front sight location of the sight accessory coincides with a screen center. Affected by the breathing shake, there is a deviation between the front sight location and the screen center location.

In some embodiments, the screen is used as a two-dimensional coordinate system, coordinates of the center of the screen are (0, 0), and the breathing shaking parameter is (−1, −1).

The breathing shaking parameter may be obtained based on any coordinate system. The value of the breathing shaking parameter may be arbitrary, and the breathing shaking parameter may be a random value in any two-dimensional direction. A coordinate system may be established by using the screen, or a coordinate system may be established by using another plane, or a coordinate system may not be established. If the coordinate system is established by using the screen, the coordinates of the screen center may be arbitrary, and a location of a front sight may be arbitrary, but needs to be located on an inner ring of the outline of the lens of the sight accessory. This is not limited in this embodiment.

Step 1402: Adjust, in real time based on the breathing shaking parameter, a display location of a targeting front sight displayed on the inner ring of the accessory outline. For example, a display position of a targeting reticle within the inner region of the outline is adjusted in real time based on the breathing simulation parameter.

To make a simulated breathing effect of the master virtual object more realistic, the breathing shaking parameter changes.

In some embodiments, at a first moment, the breathing shaking parameter is (−1, −1), and the coordinates of the screen center is (0, 0). Based on the breathing shaking parameter and the coordinates of the screen center, coordinates of the front sight location of the sight accessory are calculated to be (−1, −1).

In some embodiments, at a second moment, the breathing shaking parameter is (1, −1), and the coordinates of the screen center is (0, 0). Based on the breathing shaking parameter and the coordinates of the screen center, coordinates of the front sight location of the sight accessory are calculated to be (1, −1).

According to the coordinates of the front sight location calculated above, the location of the front sight is displayed in the screen-based two-dimensional coordinate system.

Based on the breathing shaking parameter, a display location of the targeting front sight displayed on the inner ring of the accessory outline is adjusted in real time. Breathing of the master virtual object is a continuous action, and therefore, the breathing shaking parameter is also continuous, causing a shake of the virtual item to be also continuous. There are countless moments in a period of time, and the front sight location is different at different moments. In the foregoing example, only two moments, namely the first moment and the second moment, are listed. When the front sight location is adjusted in real time, reference may be made to the breathing shaking parameter at any plurality of moments. This is not limited in this embodiment.

Step 1403: Adjust, in real time, a display area of the eyepiece end shadow and a display area of the objective lens end shadow on the inner ring of the accessory outline based on the breathing shaking parameter. For example, display areas of the eyepiece shadow and the objective lens shadow within the inner region of the outline are adjusted in real time based on the breathing simulation parameter.

The breathing shaking parameter affects the front sight location of the sight accessory, and the front sight location is the center of the objective lens end shadow. Therefore, the display area of the objective lens end shadow on the inner ring of the accessory outline is adjusted in real time based on the breathing shaking parameter. That is, the location of the objective lens end shadow is determined based on a changing front sight location, thereby determining the display area of the objective lens end shadow in the outline of the sight accessory. The center of the eyepiece end shadow is a preset center location. The preset center location is in the outline of the sight accessory, and keeps unchanged with a relative location of the sight accessory. Therefore, the display area of the eyepiece end shadow on the inner ring of the accessory outline is adjusted in real time based on the breathing shaking parameter, that is, the location of the objective lens end shadow is determined based on the changing location of the sight accessory.

In some embodiments, the center of the objective lens end shadow is a circular area, and the center of the eyepiece end shadow is a circular area.

In some embodiments, a circle is created with the front sight location as a center and a first preset length as a radius. The circle is a visible area on the objective lens end. The visible area on the objective lens end has an overlapping relationship with the eyepiece lens of the sight accessory. In the outline of the sight accessory, a part in which the visible area of the objective lens end overlaps with the eyepiece lens of the sight accessory is the visible area of the sight accessory, and a remaining area is the display area of the objective lens end shadow.

In some embodiments, a circle is created with the preset center location as a center and a second preset length as a radius. The circle is a visible area on the eyepiece end. The visible area on the eyepiece end has an overlapping relationship with the eyepiece lens of the sight accessory. In the outline of the sight accessory, a part in which the visible area of the eyepiece end overlaps with the eyepiece lens of the sight accessory is the visible area of the sight accessory, and a remaining area is the display area of the eyepiece end shadow.

In some embodiments, the eyepiece lens of the sight accessory is in a shape of a circle, and an outline shadow is added along the outline of the lens of the sight accessory. The display area of the objective lens end shadow and the display area of the eyepiece end shadow are superimposed in the outline of the sight accessory. Based on this, if the outline shadow continues to be superimposed, a part, located in the outline of the sight accessory, on which the shadow is not superimposed is a part of an image of the virtual scene that the master virtual object can observe through the sight accessory.

The center of the objective lens end shadow may be in any shape, that is, the visible area on the objective lens end may be in any shape. The center of the eyepiece end shadow may be in any shape, that is, the visible area on the eyepiece end may be in any shape. If the visible area on the objective lens end is in a shape of a circle, a radius of the visible area on the objective lens end may be any legal preset length. If the visible area on the eyepiece end is in a shape of a circle, a radius of the visible area on the eyepiece end may be any legal preset length. The visible area on the objective lens end and the eyepiece lens of the sight accessory may or may not have an overlapping relationship. The visible area on the eyepiece end and the eyepiece lens of the sight accessory may or may not have an overlapping relationship. A shape of the eyepiece lens of the sight accessory may be arbitrary. Therefore, a shape of the outline shadow added along the outline of the lens of the sight accessory may also be arbitrary. This is not limited in this embodiment.

In the method provided in this embodiment of this disclosure, the breathing shaking parameter is obtained, to simulate influence of the breathing of the master virtual object on the virtual gun, and adjust, in real time, the shadow in the outline of the sight accessory on the virtual gun based on the breathing shake, which improves a sense of reality of the image, improves an experience of the player when controlling the virtual object to perform shooting, and improves accuracy when the virtual object performs aiming down sight and shooting.

In the method provided in this embodiment of this disclosure, the breathing shaking parameter is obtained, to adjust, in real time, the front sight location of the sight accessory based on the breathing shaking parameter. As a result, there is a deviation between the front sight of the sight accessory and the screen center, which improves the sense of reality of the image, and improves the experience of the player when controlling the virtual object to perform shooting.

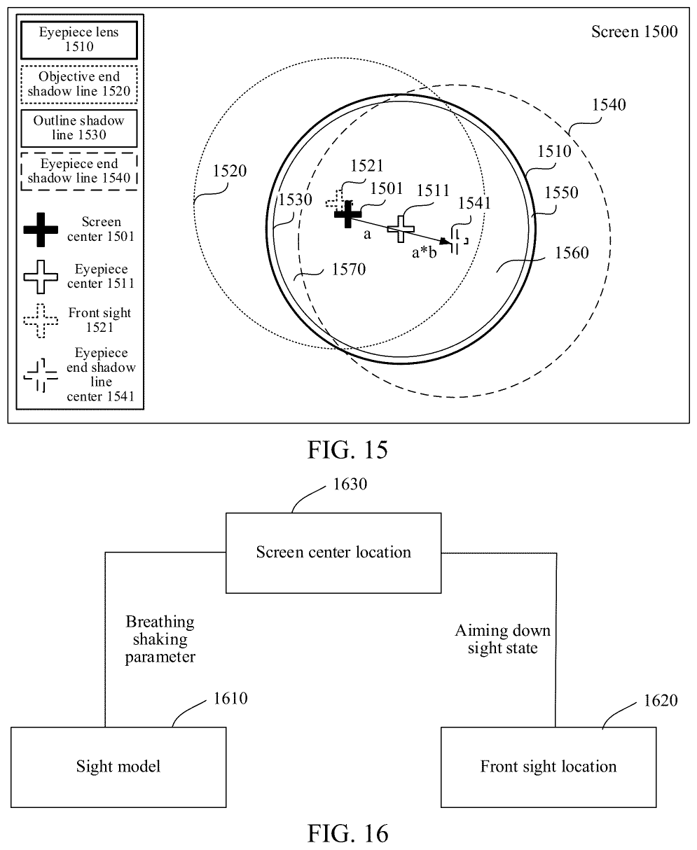

FIG. 15 is a schematic diagram of a virtual item display method according to another embodiment of this disclosure. As shown in FIG. 15,

in some embodiments, a screen 1500 includes the following contents: a screen center 1501, an eyepiece lens 1510 of a sight accessory, an eyepiece center 1511, an objective lens end shadow line 1520, a front sight 1521, an outline shadow line 1530, an eyepiece end shadow line 1540, an eyepiece end shadow line center 1541, a first shadow 1550, a second shadow 1560, and a third shadow 1570.

The screen 1500 displays the screen center 1501, the eyepiece lens 1510 of the sight accessory, and the eyepiece center 1511. A distance between the screen center 1501 and the eyepiece center 1511 is a preset distance a.
1. A circle is created with the eyepiece center 1511 as a center and a first preset length as a radius. The circle is the outline shadow line 1530. The outline shadow line 1530 partially coincides with the eyepiece lens 1510 of the sight accessory, and a non-coinciding part located in the eyepiece lens 1510 is a first shadow 1550. A shadow, namely, an outline shadow of the sight accessory, is superimposed at the first shadow 1550.
2. After a breathing shaking parameter of a master virtual object is obtained, a location of the front sight 1521 of the sight accessory is calculated based on the breathing shaking parameter and a location of the screen center 1501. A circle is created with the front sight 1521 as a center and a second preset length as a radius. The circle is the objective lens end shadow line 1520. The objective lens end shadow line 1520 coincides with the eyepiece lens 1510 of the sight accessory, and a non-coinciding part located in the eyepiece lens 1510 is a second shadow 1560. A shadow, namely, an objective lens end shadow of the sight accessory, is superimposed at the second shadow 1560.
3. The screen center 1501 is connected to the eyepiece center 1511, and an extension vector in a direction from the screen center 1501 to the eyepiece center 1511 is established. An extension length is based on a distance a between the screen center 1501 and the eyepiece center 1511. a is multiplied by a preset parameter b, to obtain coordinates, namely, the eyepiece end shadow line center 1541, that stop at the extension direction a*b. A circle is created with the eyepiece end shadow line center 1541 as a center and a third preset length as a radius. The circle is the eyepiece end shadow line 1540. The eyepiece end shadow line 1540 partially coincides with the eyepiece lens 1510 of the sight accessory, and a non-coinciding part located in the eyepiece lens 1510 is a third shadow 1570. A shadow, namely, an eyepiece end shadow of the sight accessory, is superimposed at the third shadow 1570.

A value of a length of the preset distance a between the screen center 1501 and the eyepiece center 1511 may be any legal number, including but not limited to a non-negative integer, a non-negative decimal, and the like. A length unit of the preset distance a may be any legal length unit, and the length of the preset distance a does not exceed a range that may be displayed on a screen.

A preset parameter b can be any legal number, including but not limited to a positive integer, and the like. A value of the preset parameter b is related to a virtual item used by the master virtual object. That is, when the virtual object uses different virtual guns, the value of the corresponding preset parameter b is also different.

For example, FIG. 16 is a schematic diagram of aiming down sight display content according to an embodiment of this disclosure. As shown in FIG. 16, in a process in which a virtual object performs an aiming down sight operation by using a sight accessory, a virtual scene image includes a sight model 1610, a front sight location 1620, and a screen center location 1630.

The sight model 1610 is related to a playing moment of an aiming down sight animation corresponding to the aiming down sight operation, that is, as the aiming down sight animation plays, the sight model 1610 adjusts, in real time, a corresponding aiming down sight state. When the aiming down sight state corresponding to the sight model 1610 is completed, a center location of a lens corresponding to the sight model 1610 overlaps with a screen center location corresponding to the virtual scene image. A starting location of the sight model 1610 refers to a location of the sight model 1610 in a state in which the sight is not opened. There is a location deviation between the front sight location 1620 and the screen center location 1630. This is caused by a breathing shaking parameter corresponding to a master virtual object. The breathing shaking parameter is a random value in a two-dimensional direction with a low amplitude value.

For example, when the sight model 1610 reaches a fully aiming down sight state, an inner ring of an accessory outline of the sight model 1610 displays three shadows, including an eyepiece end shadow, an objective lens end shadow, and an outline shadow. The three shadows are related to the sight model 1610, the front sight location 1620, and the screen center location 1630.

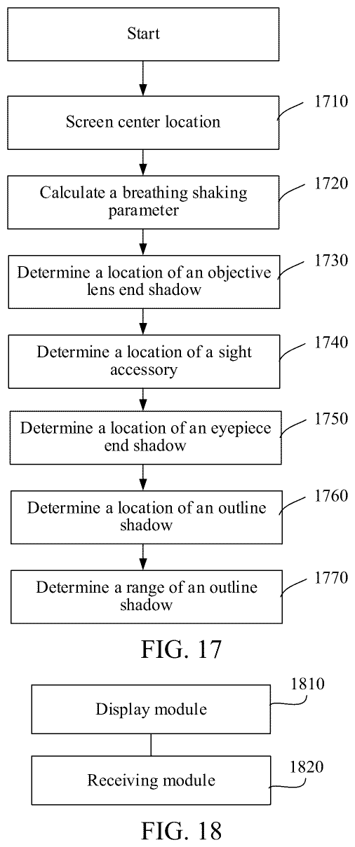

For example, FIG. 17 is a flowchart of a shadow display determining method according to an embodiment of this disclosure. As shown in FIG. 17, the method includes the following steps.

Step 1710: Obtain a screen center location.

The screen center location is determined according to an aiming down sight state of the sight model.

Step 1720: Calculate a breathing shaking parameter.

The corresponding breathing shaking parameter is set when a master virtual object holds a virtual gun.

Step 1730: Determine a location of an objective lens end shadow.

The breathing shaking parameter affects the front sight location of the sight accessory, and the front sight location is the center of the objective lens end shadow. Therefore, the display area of the objective lens end shadow on the inner ring of the accessory outline is adjusted in real time based on the breathing shaking parameter. That is, the location of the objective lens end shadow is determined based on a changing front sight location, thereby determining the display area of the objective lens end shadow in the outline of the sight accessory.

Step 1740: Determine a location of the sight accessory.

The location of the corresponding sight accessory is determined according to a

location of a sight model in a virtual scene.

Step 1750: Determine a location of an eyepiece end shadow.

A center of the eyepiece end shadow is a preset center location. The preset center location is in an outline of the sight accessory, and keeps unchanged with a relative location of the sight accessory.

Step 1760: Determine a location of an outline shadow.

The location corresponding to the outline shadow is determined according to the location of the accessory outline in the sight accessory, where the location of the accessory outline is the same as the location corresponding to the outline shadow.

Step 1770: Determine a range of the outline shadow.

The range of the outline shadow needs to be determined according to actual needs.

FIG. 18 is a structural block diagram of a virtual item display apparatus according to an embodiment of this disclosure. As shown in FIG. 18, the apparatus includes:
a display module 1810, configured to display a first scene image of observing a virtual scene from a viewing angle of a master virtual object, the master virtual object holding a virtual gun, the virtual gun being equipped with a sight accessory, and the sight accessory including an eyepiece end and an objective lens end;
a receiving module 1820, configured to receive an aiming down sight action, the aiming down sight action being an action that enables the master virtual object to observe, through the sight accessory, the virtual scene;
the display module 1810, further configured to display a second scene image of observing, through the sight accessory, the virtual scene, the second scene image including an accessory outline corresponding to the sight accessory; and
the display module 1810, further configured to display an eyepiece end shadow and an objective lens end shadow on an inner ring of the accessory outline, the eyepiece end shadow being a shadow produced by a lens barrel of the eyepiece end, and the objective lens end shadow being a shadow produced by a lens barrel of the objective lens end.

In an embodiment, the apparatus further includes:
an obtaining module 1830, configured to obtain an observation angle at which the master virtual object observes, through the sight accessory, the virtual scene;
a determining module 1840, configured to determine, based on the observation angle, a first display area corresponding to the eyepiece end shadow on the inner ring of the accessory outline; and determine, based on the observation angle, a second display area corresponding to the objective lens end shadow on the inner ring of the accessory outline; and
the display module 1810, further configured to display the eyepiece end shadow and the objective lens end shadow on the inner ring of the accessory outline based on the first display area and the second display area.

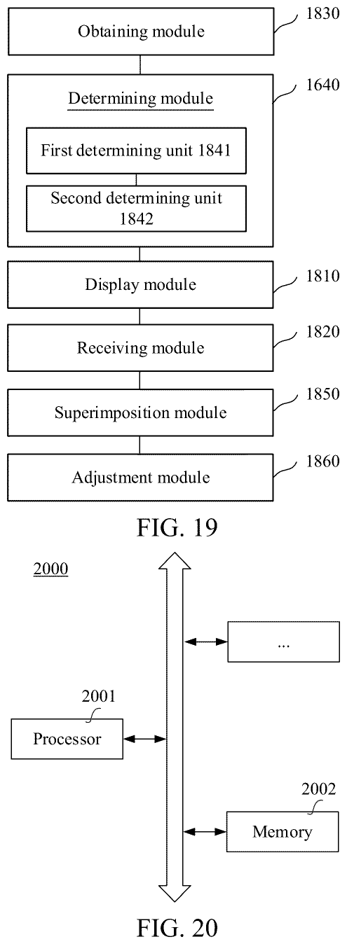

In an embodiment, as shown in FIG. 19, the determining module 1840 includes:
a first determining unit 1841, configured to determine a first relative location relationship, at the observation angle, between an inner wall of a lens barrel of an eyepiece of the sight accessory and eyes of the master virtual object; and determine, based on the first relative location relationship, the first display area corresponding to the eyepiece end shadow on the inner ring of the accessory outline; and
the determining module 1840 further includes:
a second determining unit 1842, configured to determine a second relative location relationship, at the observation angle, between an inner wall of a lens barrel of an objective lens of the sight accessory and the eyes of the master virtual object; and determine, based on the second relative location relationship, the second display area corresponding to the objective lens end shadow on the inner ring of the accessory outline.

In an embodiment, a lens on an eyepiece end of the sight accessory is in a shape of a circle.

In an embodiment, the determining module 1840 is further configured to determine an overlapping relationship between a lens display area and an eyepiece penetration area based on the first relative location relationship, where the lens display area is a lens area range in which observation is performed through the sight accessory, and the eyepiece penetration area is a lens area range in which observation is performed through the lens on the eyepiece end; and use an area range of the lens display area that does not overlap with the eyepiece penetration area as the first display area corresponding to the eyepiece end shadow.

In an embodiment, a lens on an objective lens end of the sight accessory is in a shape of a circle.

In an embodiment, the determining module 1840 is further configured to determine an overlapping relationship between a lens display area and an objective lens penetration area based on the second relative location relationship, where the lens display area is a lens area range in which observation is performed through the sight accessory, and the objective lens penetration area is a lens area range in which observation is performed through the lens on the objective lens end; and use an area range of the lens display area that does not overlap with the objective lens penetration area as the second display area corresponding to the objective lens end shadow.

In an embodiment, the apparatus further includes:
the obtaining module 1830, configured to obtain a candidate lens display area, where the candidate lens display area is a light-transmitting area range corresponding to the sight accessory; and
a superimposition module 1850, configured to superimpose a preset black edge shadow on an inner ring of the candidate lens display area, and use an area in a preset black edge shadow range as the lens display area.

In an embodiment, the display module 1810 is further configured to display an outline shadow based on the candidate lens display area, where the outline shadow is a shadow produced by a lens of the sight accessory being blocked by light in the virtual scene.

In an embodiment, the apparatus further includes:
the obtaining module 1830, further configured to obtain a breathing shaking parameter of the master virtual object, where the breathing shaking parameter is a case in which the master virtual object shakes when holding the virtual gun; and
an adjustment module 1860, configured to adjust, in real time, a display area of the eyepiece end shadow and a display area of the objective lens end shadow on the inner ring of the accessory outline based on the breathing shaking parameter.

In an embodiment, the adjustment module 1860 is further configured to adjust, in real time based on the breathing shaking parameter, a display location of a targeting front sight displayed on the inner ring of the accessory outline.

In summary, in the apparatus provided in this embodiment of this disclosure, the eyepiece end shadow and the objective lens end shadow are added to an inner ring of an outline of the sight accessory, and an outline shadow is added inside an outline of the lens of the sight accessory. After opening the sight accessory, the master virtual object performs observation through the sight accessory. As an aiming down sight animation plays on a terminal screen or a location of the sight accessory changes, a changing process of the eyepiece end shadow and the objective lens end shadow at different moments may be viewed, making performance of the lens of the sight accessory richer, thereby improving the sense of reality of the image, and also enhancing an immersive experience of a player when controlling a current master virtual object to perform shooting.

FIG. 20 is a structural block diagram of a computer device 2000 according to an embodiment of this disclosure. The computer device 2000 may be a smartphone, a tablet computer, a Moving Picture Experts Group Audio Layer III (MP3) player, a Moving Picture Experts Group Audio Layer IV (MP4) player, a notebook computer, or a desktop computer. The computer device 2000 may be further referred to as another name such as user equipment, a portable terminal, a laptop terminal, or a desktop terminal.

The computer device 2000 includes a processor 2001 (i.e., processing circuitry) and a memory 2002 (i.e., a non-transitory computer-readable storage medium).

The processor 2001 may include one or more processing cores, for example, a 4-core processor or an 8-core processor. The processor 2001 may be implemented by using at least one hardware form of a digital signal processor (DSP), a field programmable gate array (FPGA), and a programmable logic array (PLA). The processor 2001 may also include a main processor and a coprocessor. The main processor is a processor configured to process data in an awake state, and is also referred to as a central processing unit (CPU). The coprocessor is a low power consumption processor configured to process the data in a standby state. In some embodiments, the processor 2001 may be integrated with a graphics processing unit (GPU). The GPU is configured to be responsible for rendering and drawing content that a display needs to display. In some embodiments, the processor 2001 may further include an artificial intelligence (AI) processor. The AI processor is configured to process computing operations related to machine learning.

The memory 2002 may include one or more computer-readable storage media that may be non-transitory. The memory 2002 may further include a high-speed random access memory and a non-volatile memory, for example, one or more disk storage devices or flash storage devices. In some embodiments, the non-transitory computer-readable storage medium in the memory 2002 is configured to store at least one instruction, and the at least one instruction being configured to be executed by the processor 2001 to implement the virtual item display method provided in the method embodiments of this disclosure.

In some embodiments, the computer device 2000 further includes other components. A person skilled in the art may understand that the structure shown in FIG. 20 does not constitute a limitation on the terminal 2000 and that the computer device may include more or fewer components than those shown in the figure, a combination of some components, or different component arrangements.

In an example, the computer-readable storage medium may include: a read-only memory (ROM), a random access memory (RAM), a solid-state drive (SSD), an optical disc, or the like. The RAM may include a resistance random access memory (ReRAM) and a dynamic random access memory (DRAM). The sequence numbers of the foregoing embodiments of this disclosure are merely for description purpose, and are not intended to indicate the preference among the embodiments.

An embodiment of this disclosure further provides a computer device, including a processor and a memory, the memory storing at least one instruction, at least one segment of program, a code set, or an instruction set, the at least one instruction, the at least one segment of program, the code set, or the instruction set being loaded and executed by the processor to implement the virtual item display method according to any one of the foregoing embodiments of this disclosure.

An embodiment of this disclosure further provides a computer-readable storage medium, storing at least one instruction, at least one segment of program, a code set, or an instruction set, the at least one instruction, the at least one segment of program, the code set, or the instruction set being loaded and executed by a processor to implement the virtual item display method according to any one of the foregoing embodiments of this disclosure.

An embodiment of this disclosure further provides a computer program product or a computer program. The computer program product or the computer program includes computer instructions, the computer instructions being stored in a computer-readable storage medium. A processor of a computer device reads the computer instructions from the computer-readable storage medium and executes the computer instructions, to enable the computer device to perform the foregoing virtual item display method according to any one of the foregoing embodiments.

What is claimed is:

1. A method for displaying a virtual item in a virtual scene, comprising:
displaying a first scene image of the virtual scene from a perspective of a controllable virtual character;
receiving an input to utilize a sight accessory on a virtual weapon held by the controllable virtual character;
displaying a second scene image of the virtual scene as viewed through the sight accessory, the second scene image including an outline of the sight accessory; and
rendering, within an inner region of the outline, an eyepiece shadow and an objective lens shadow, wherein
the eyepiece shadow simulates a shadow cast by an eyepiece end of the sight accessory, and
the objective lens shadow simulates a shadow cast by an objective lens end of the sight accessory.

2. The method according to claim 1, wherein the rendering the eyepiece shadow and the objective lens shadow comprises:
determining an observation angle of the controllable virtual character when viewing through the sight accessory;
determining, based on the observation angle, a first display area corresponding to the eyepiece shadow and a second display area corresponding to the objective lens shadow within the inner region of the outline; and
rendering the eyepiece shadow in the first display area and the objective lens shadow in the second display area.

3. The method according to claim 2, wherein the determining the first display area comprises:
determining a first spatial relationship between an inner wall of the eyepiece end and a viewpoint of the controllable virtual character at the observation angle; and determining the first display area based on the first spatial relationship; and
the determining the second display area comprises:
determining a second spatial relationship between an inner wall of the objective lens end and the viewpoint of the controllable virtual character at the observation angle; and determining the second display area based on the second spatial relationship.

4. The method according to claim 3, wherein the eyepiece end has a circular shape; and
the determining the first display area further comprises:
identifying an overlap between a lens display area and an eyepiece visibility area based on the first spatial relationship, wherein the lens display area is a visible region through the sight accessory, and the eyepiece visibility area is a visible region through the eyepiece end; and
determining the first display area as a portion of the lens display area that does not overlap with the eyepiece visibility area.

5. The method according to claim 3, wherein the objective lens end has a circular shape; and
the determining the second display area further comprises:
identifying an overlap between a lens display area and an objective lens visibility area based on the second spatial relationship, wherein the lens display area is a visible region through the sight accessory, and the objective lens visibility area is a visible region through the objective lens end; and
determining the second display area as a portion of the lens display area that does not overlap with the objective lens visibility area.

6. The method according to claim 4, further comprising:
determining a candidate lens display area, wherein the candidate lens display area is a light-transmitting region of the sight accessory;
applying a preset dark edge shadow to an inner perimeter of the candidate lens display area; and
determining the lens display area as a region within the preset dark edge shadow.

7. The method according to claim 6, further comprising:
rendering an outline shadow based on the candidate lens display area, wherein the outline shadow simulates a shadow cast by an edge of a lens of the sight accessory based on light in the virtual scene.

8. The method according to claim 1, further comprising:
obtaining a breathing simulation parameter for the controllable virtual character, wherein the breathing simulation parameter is a simulated shaking effect when the controllable virtual character holds the virtual weapon; and
adjusting, in real time, display areas of the eyepiece shadow and the objective lens shadow within the inner region of the outline based on the breathing simulation parameter.

9. The method according to claim 8, further comprising:
adjusting, in real time, based on the breathing simulation parameter, a display position of a targeting reticle within the inner region of the outline.

10. A virtual item display apparatus, comprising:
processing circuitry configured to:
display a first scene image of a virtual scene from a perspective of a controllable virtual character;
receive an input to utilize a sight accessory on a virtual weapon held by the controllable virtual character;
display a second scene image of the virtual scene as viewed through the sight accessory, the second scene image including an outline of the sight accessory; and
render, within an inner region of the outline, an eyepiece shadow and an objective lens shadow, wherein
the eyepiece shadow simulates a shadow cast by an eyepiece end of the sight accessory, and
the objective lens shadow simulates a shadow cast by an objective lens end of the sight accessory.

11. The apparatus according to claim 10, wherein the processing circuitry is configured to:
determine an observation angle of the controllable virtual character when viewed through the sight accessory;
determine, based on the observation angle, a first display area corresponding to the eyepiece shadow and a second display area corresponding to the objective lens shadow within the inner region of the outline; and
render the eyepiece shadow in the first display area and the objective lens shadow in the second display area.

12. The apparatus according to claim 11, wherein the processing circuitry is configured to:
determine a first spatial relationship between an inner wall of the eyepiece end and a viewpoint of the controllable virtual character at the observation angle;
determine the first display area based on the first spatial relationship;
determine a second spatial relationship between an inner wall of the objective lens end and the viewpoint of the controllable virtual character at the observation angle; and
determine the second display area based on the second spatial relationship.

13. The apparatus according to claim 12, wherein
the eyepiece end has a circular shape; and
the processing circuitry is configured to:
identify an overlap between a lens display area and an eyepiece visibility area based on the first spatial relationship, wherein the lens display area is a visible region through the sight accessory, and the eyepiece visibility area is a visible region through the eyepiece end, and
determine the first display area as a portion of the lens display area that does not overlap with the eyepiece visibility area.

14. The apparatus according to claim 12, wherein the objective lens end has a circular shape; and
the processing circuitry is configured to:
identify an overlap between a lens display area and an objective lens visibility area based on the second spatial relationship, wherein the lens display area is a visible region through the sight accessory, and the objective lens visibility area is a visible region through the objective lens end; and
determine the second display area as a portion of the lens display area that does not overlap with the objective lens visibility area.

15. The apparatus according to claim 13, wherein the processing circuitry is configured to:
determine a candidate lens display area, wherein the candidate lens display area is a light-transmitting region of the sight accessory;
apply a preset dark edge shadow to an inner perimeter of the candidate lens display area; and
determine the lens display area as a region within the preset dark edge shadow.

16. The apparatus according to claim 15, wherein the processing circuitry is configured to:
render an outline shadow based on the candidate lens display area, wherein the outline shadow simulates a shadow cast by an edge of a lens of the sight accessory based on light in the virtual scene.

17. The apparatus according to claim 10, wherein the processing circuitry is configured to:
obtain a breathing simulation parameter for the controllable virtual character, wherein the breathing simulation parameter is a simulated shaking effect when the controllable virtual character holds the virtual weapon; and
adjust, in real time, display areas of the eyepiece shadow and the objective lens shadow within the inner region of the outline based on the breathing simulation parameter.

18. The apparatus according to claim 17, where in the processing circuitry is configured to:
adjust, in real time, based on the breathing simulation parameter, a display position of a targeting reticle within the inner region of the outline.

19. A non-transitory computer-readable storage medium, storing instructions which when executed by a processor cause the processor to perform:
displaying a first scene image of a virtual scene from a perspective of a controllable virtual character;
receiving an input to utilize a sight accessory on a virtual weapon held by the controllable virtual character;
displaying a second scene image of the virtual scene as viewed through the sight accessory, the second scene image including an outline of the sight accessory; and
rendering, within an inner region of the outline, an eyepiece shadow and an objective lens shadow, wherein
the eyepiece shadow simulates a shadow cast by an eyepiece end of the sight accessory, and
the objective lens shadow simulates a shadow cast by an objective lens end of the sight accessory.

20. The non-transitory computer-readable storage medium according to claim 19, wherein the rendering the eyepiece shadow and the objective lens shadow comprises:
determining an observation angle of the controllable virtual character when viewing through the sight accessory;
determining, based on the observation angle, a first display area corresponding to the eyepiece shadow and a second display area corresponding to the objective lens shadow within the inner region of the outline; and
rendering the eyepiece shadow in the first display area and the objective lens shadow in the second display area.
